(19) United States
(12) Patent Application Publication
(10) Pub. No.: US 2026/0100849 A1
(43) Pub. Date: Apr. 9, 2026

(54) SUPPORTING SECURE COMMUNICATIONS BETWEEN NETWORK FUNCTIONS

(71) Applicant: Telefonaktiebolaget LM Ericsson (publ), Stockholm (SE)

(72) Inventors: Barbara GHIGLINO, Genova (IT); Valentino IGNOTI, Campomorone (IT)

(21) Appl. No.: 19/120,881

(22) PCT Filed: Oct. 24, 2022
(86) PCT No.: PCT/SE2022/050971

§ 371 Date: Apr. 14, 2025

(51) Int. Cl. H04L 9/32; H04L 9/30

(52) U.S. Cl. CPC H04L 9/3263; H04L 9/30

(57) ABSTRACT

A method for supporting secure communications between network functions (NFs) deployed in a network having two or more network slices is provided. The method is performed by a computing device and comprises: for each one of the NFs, and for each interface of the NF, if the interface does not have a valid digital certificate: obtaining based on one or more attributes and on one or more isolation requirements associated with the NF, a digital certificate signed by a certification authority (CA), and a trusted CA certificate of the CA, transmitting, to the NF, the obtained digital certificate; identifying one or more further NFs connected to the NF; and if one or more of the one or more further NFs do not have the trusted CA certificate, transmitting the trusted CA certificate to the one or more further NFs not having the trusted CA certificate.

### TECHNICAL FIELD

The invention relates to a method and a device for supporting secure communication between network functions deployed in a network having two or more network slices, a corresponding computer program, and a corresponding computer program product.

### BACKGROUND

Network slicing is a network architecture enabling virtualized and independent logical networks on the same shared infrastructure. From a network operator point of view, a network slice is an independent end-to-end logical network that runs on a shared physical infrastructure. An implementation of a network slice is represented by a network slice instance (NSI), i.e., a set of network function (NF) instances and the required resources (e.g., compute, storage, and networking resources). A network slice could span across multiple parts of a network (e.g., terminal, access network, core network, transport network, cloud) and could be deployed across multiple network operators. The property of a network slice to operate without any influence of other network slices utilizing the same infrastructure is referred to as isolation. Isolation ensures that congestion, attacks, and lifecycle-related events (e.g., scaling in/out) on one network slice do not negatively impact other existing network slices.

Security risks in a network with slicing comprise: (i) privacy risk of (mobile) terminal access to the network; and (ii) risk of communications between network functions belonging to different network slices. Further information on security challenges of network slicing can be found in “Security Consideration for 5G Network Operation v1.0”, NGMN Alliance, https://www.ngmn.org/wp-content/uploads/210804-NGMN-Security-Considerations-for-5G-Network-Operation-V1.0.pdf, 2021.

### SUMMARY

It is an object of the invention to provide an improved alternative to the above techniques and prior art. More specifically, it is an object of the invention to provide improved secure communications between network functions (NFs) deployed in a network having two or more network slices. This and other objects of the invention are achieved by means of different aspects of the invention, as defined by the independent claims. Embodiments of the invention are characterized by the dependent claims.

According to a first aspect of the invention, a method for supporting secure communications between NFs deployed in a network having two or more network slices is provided. The method is performed by a computing device. The method comprises, for each one of the NFs, and for each interface of the NF, if the interface does not have a valid digital certificate, obtaining a digital certificate signed by a certification authority (CA) and a trusted CA certificate of the CA. The digital certificate is obtained based on one or more attributes and on one or more isolation requirements associated with the NF. The method further comprises transmitting, to the NF, the obtained digital certificate. The method further comprises identifying one or more further NFs connected to the NF. The method further comprises, if one or more of the one or more further NFs do not have the trusted CA certificate, transmitting the trusted CA certificate to the one or more further NFs not having the trusted CA certificate.

According to a second aspect of the invention, a computing device for supporting secure communications between NFs deployed in a network having two or more network slices is provided. The computing device comprises a processor and a memory. The memory has stored thereon instructions executable by the processor, wherein the instructions, when executed by the processor, cause the computing device to, for each one of the NFs, and for each interface of the NF, if the interface does not have a valid digital certificate obtain a digital certificate signed by a CA, and a trusted CA certificate of the CA. The digital certificate is obtained based on one or more attributes and on one or more isolation requirements associated with the NF. The computing device is further operative to transmit, to the NF, the obtained digital certificate. The computing device is further operative to identify one or more further NFs connected to the NF. The computing device is further operative to, if one or more of the one or more further NFs do not have the trusted CA certificate, transmit the trusted CA certificate to the one or more further NFs not having the trusted CA certificate.

According to a third aspect of the invention, a computer program is provided. The computer program comprises instruction which, when run in a processing unit on a computing device, cause the computing device to, for each one of the NFs, and for each interface of the NF, if the interface does not have a valid digital certificate, obtain a digital certificate signed by a CA, and a trusted CA certificate of the CA. The digital certificate is obtained based on one or more attributes and on one or more isolation requirements associated with the NF. The instructions further cause the computing device to transmit to the NF the obtained digital certificate. The instructions further cause the computing device to identify one or more further NFs connected to the NF. The instructions further cause the computing device to, if one or more of the one or more further NFs do not have the trusted CA certificate, transmit the trusted CA certificate to the one or more further NFs not having the trusted CA certificate.

According to a fourth aspect of the present invention there is provided a computer program product comprising a computer readable storage medium on which a computer program according to an embodiment of the third aspect of the invention is stored.

Certain embodiments may provide one or more of the following technical advantages. Trusted domains are automatically identified without any manual activity, reducing the risk of human errors. Not required communications between NFs may be inhibited by creating a CA for each interface of a NF and distributing the trusted CA certificate only to counterparts allowed of communicate to the interface. Deployment of the trusted domains in a network may be dynamically updated by a centralized orchestrator that may react in runtime to a different network configuration or to the deployment of new network slices, as reflected in changes of topologies of the network slices.

### BRIEF DESCRIPTION OF THE DRAWINGS

For better understanding of the present disclosure, and to show more readily how the invention may be carried into effect, reference will now be made, by way of example, to the following drawings, in which:

FIG. 1 shows an example scenario according to embodiments of the invention;

FIG. 2 shows a flow chart illustrating a method for supporting secure communications between network functions deployed in a network having two or more network slices, according to embodiments of the invention;

FIG. 3a shows an example flow chart illustrating supporting secure communications between network functions deployed in a network having two or more network slices, according to embodiments of the invention;

FIG. 3b shows a further example flow chart illustrating supporting secure communications between network functions deployed in a network having two or more network slices, according to further embodiments of the invention;

FIG. 4 shows an example scenario comprising a dedicated network function according to embodiments of the invention;

FIG. 5 shows an example scenario comprising a shared network function according to embodiments of the invention;

FIG. 6 shows an example scenario comprising a shared network function with dedicated interfaces according to embodiments of the invention; and

FIG. 7 shows a block diagram depicting a computing device according to embodiments of the invention.

### DETAILED DESCRIPTION

Embodiments will be illustrated herein with reference to the accompanying drawings. These embodiments are provided by way of example so that this disclosure will be thorough and complete, and will fully convey the scope of the inventive concept to those skilled in the art.

Communications between network functions (NFs) deployed in different network slices (or network slice instances) may incur security risks, such as unauthorized use of shared resources and unauthorized connections between NFs deployed in different network slices. The failure of one network slice or its resources may adversely affect the operation of other slices because of the sharing of physical infrastructure between network slices, or the consume of shared resources by a single network slice may cause lack of resources and support for other network slices.

Therefore, it is important to define trusted domains (or domains of trust) in a network with two or more network slices. A trusted domain is a group of entities, such as NFs, that need to authenticate each other to be able to communicate in a secure way. Trusted domains are usually manually identified and a public key infrastructure (PKI) is configured to generate digital certificates for authentication of the entities belonging to a same trusted domain.

The solution disclosed herein makes it possible to dynamically and automatically deploy and maintain trusted domains in a network having two or more network slices. This is accomplished by creating a certificate authority (CA) and a digital certificate signed by the CA for each interface of an NF of a trusted domain, and distributing a trusted CA certificate to the further NFs belonging to the trusted domain. By exchanging their digital certificates, the NFs of the trusted domain may authenticate each other and establish secure communications.

The solution disclosed herein provides one or more of the following technical advantages:
trusted domains are automatically identified without any manual activity, reducing the risk of human errors;
not required inter-communications between NFs may be inhibited by creating a CA for each interface of a NF and distributing the trusted CA certificate only to counterparts allowed to communicate with the interface;
deployment of the trusted domains in a network may be dynamically updated by a centralized orchestrator that may react in runtime to a different network configuration or to the deployment of new network slices, as reflected in changes of topologies of the network slices.

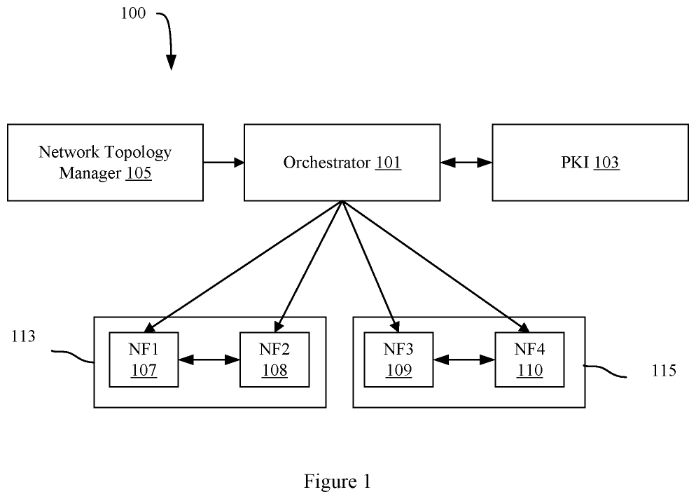

FIG. 1 schematically shows an example of a system 100 in which a solution according to embodiments of the invention may be implemented. The system 100 comprises an orchestrator 101, a PKI 103, a slice network topology manager 105, and a network comprising four NFs, NF1-NF4, 107-110.

In the example system 100, the orchestrator 101 is an entity responsible for instantiating network slices and managing the network slices'life cycle. The orchestrator 101 may be an entity performing a method according to embodiments of the invention. An example of such an orchestrator is a service management and orchestration (SMO) node which provides automation and orchestration of an Open Random Access Network (RAN) domain. The orchestrator 101 may obtain information of a topology of the network comprising the NFs from a slice network topology manager 105. The slice network topology manager 105 may be an entity able to discover NFs, links between the NFs, and other information about an NF, such as attributes and isolation requirements. The slice network topology manager 105 may be an external standalone component implemented on a router, gateway, Internet of things (IOT) gateway, or any device with computing, storage, and network connectivity. Alternatively, it can be an NF within the orchestrator 101.

The NFs 107-110 may be virtual network functions (VNFs) or physical network functions (PNFs). An NF may be shared or dedicated. An NF is shared if resources of the NF are used by two or more network slices, and an NF is dedicated if resources of the NF are used by only one network slice. Isolation requirements at a resource level define if an NF is dedicated or shared. The NFs 107-110 may span over multiple domains (e.g., terminal, access network, core network, transport network, cloud). NFs of the core network may communicate with each other via Service Base Interfaces (SBI). NFs deployed between core network and RAN may communicate via non-Service Base Interfaces. An NF may communicate with other NFs or with the orchestrator 101, exchanging, for example, signaling in relation to operations and maintenance (O&M) tasks.

NFs belonging to the same trusted domain need to authenticate each other to be able to communicate in a secure way. With reference to FIG. 1, NF1 107 and NF2 108 belong to a first trusted domain 113, and NF3 109 and NF4 110 belong to a second trusted domain 115. Examples of security protocols used on a communication channel between NFs of a trusted domain are Datagram Transport Layer Security (DTLS) for the communication channel between 5G core control plane (5GC CP) and RAN Centralized Unit Control Plane (CU-CP), and IPsec for the communications between RAN and 5GC (over interfaces N2/N3) and between 5GC and external network like enterprise network (over interface N6).

The PKI 103 is an entity that creates, signs, and manages, CAs entities and issues certificates for end entities, such as NFs. The PKI may be implemented as a fully functional external standalone PKI entity or as an NF within the orchestrator 101 itself. According to embodiments of the invention, the orchestrator 101 requests the PKI to create a new CA for each interface of each NF of a trusted domain. The created CA signs the digital certificate to be assigned to the interface. The CA acts as a trusted third party, trusted both by a subject (owner) of the digital certificate, e.g., an NF of a trusted domain, and by a party relying upon the digital certificate, e.g., one or more further NFs of the trusted domain.

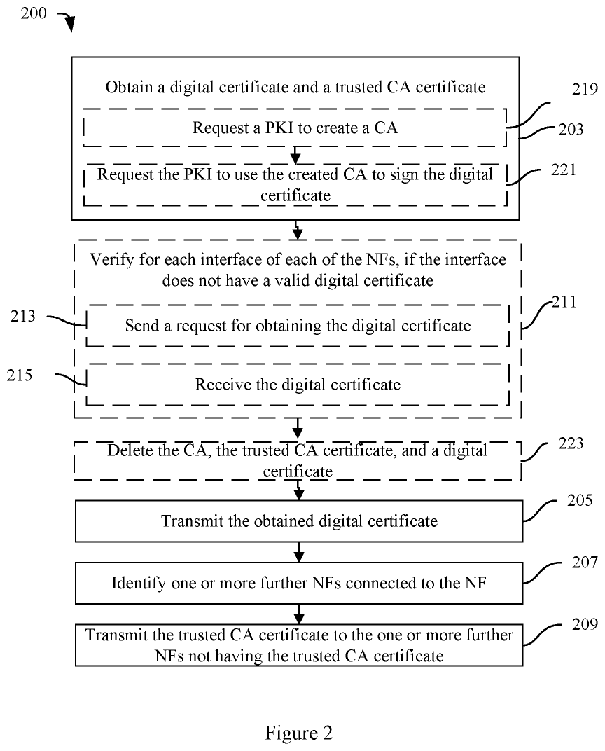

In the following, embodiments of a method 200 for supporting secure communications between NFs deployed in a network having two or more network slices are described with reference to FIG. 2. The method is performed by a computing device 700, such as an orchestrator 101.

The method 200 comprises performing the following steps for each interface of each NF of the network if the interface does not have a valid digital certificate. In other words, the following steps are preferably performed as a loop over all the NFs of the network and over all the interfaces of each NF.

The method comprises obtaining 203 a digital certificate signed by a CA and a trusted CA certificate of the CA. The obtained digital certificate is then transmitted 205 to the NF. Examples of digital certificates comprise an X.509 certificate, an OpenPretty GoodPrivacy certificate, Raw Public Key certificate, and a 1609Dot2 certificate.

The digital certificate signed by the CA and the trusted CA certificate of the CA are obtained based on one or more attributes and one or more isolation requirements associated with the NF. Optionally, the attributes associated with an NF indicate if the NF is a client, a server, or both, and/or requirements pertaining to the secure communications between the NFs, such as a level of security (low, high, medium). For example, an attribute indicating a certain level of security may be mapped to a specific key algorithm and key size (e.g., a low level of security may be mapped to Rivest-Shamir-Adleman (RSA) algorithm and 2048 bit key size, and a high level of security may be mapped to Elliptic Curve Digital Signature Algorithm (ECDSA) and 384 bit key size).

According to an embodiment of the invention, the digital certificate signed by the CA and the trusted CA certificate may be obtained by requesting 219 a PKI to create the CA, and by requesting 221 the PKI to use the created CA to sign the digital certificate. According to an embodiment of the invention, a unique CA and a unique digital certificate signed by the unique CA are created for each interface of the NF. This is different from state-of-the-art solutions where a single CA signs multiple certificates, and thus the single trusted CA certificate is used to trust multiple interfaces. A more granular definition of the CA (i.e., one per interface) allows a reduction of the size of the trust domains and a maximum possible level of isolation.

The method further comprises identifying 207 one or more further NFs connected to the NF, and if one or more of the one or more further NFs do not have the trusted CA certificate, transmitting 209 the trusted CA certificate to the one or more further NFs not having the trusted CA certificate. When the NF transmits its digital certificate to the one or more further NFs to be authenticated, the one or more further NFs use the trusted CA certificate to validate the received digital certificate.

The method 200 may further comprise deleting or creating new CAs if the network deployment changes, e.g., a connection between an NF and one or more further NFs, an interface of the NF, or the NF, is removed or added.

According to an embodiment of the invention, if any one of a connection between an NF and one or more further NFs, an interface of the NF, or the NF, is removed, the method 200 further comprises deleting 223 the CA, the trusted CA certificate, and the digital certificate assigned to the interface of the NF. The deletion of the CA does not affect other NFs since the CA was used to issue only the digital certificate of the NF, interface, or connection that is no more part of the network.

If any one of a connection between an NF and one or more further NFs, an interface of the NF, or the NF, is added, the method 200 further comprises generating 219 a new CA, and obtaining 203 a new trusted CA certificate and a new digital certificate assigned to the interface of the NF.

The method 200 comprises determining 211 if an interface of an NF does not have a valid digital certificate. For instance, the interface may not have a valid digital certificate because the NF has just been deployed, and thus it does not have a digital certificate yet, or the interface may have a digital certificate, but the digital certificate is not valid because it has expired or has been revoked. In case of digital certificate expiration, the computing device 700 may maintain a database with enrolled digital certificates and corresponding expiration dates. To verify if a digital certificate has expired, the computing device 700 may periodically check the information in the database to evaluate the remaining validity. In case of digital certificate revocation, the computing device 700 may implement an online certificate status protocol (OCSP) client to check the digital certificate validity towards the PKI or it may periodically download certificate revocation list (CRL) files from a CRL issuer, which is typically the CA which also has issued the corresponding digital certificates, or alternatively some other trusted authority.

According to an embodiment of the invention, the verification 211, for each interface of each of the NFs, if the interface does not have a valid digital certificate comprises sending 213, to the NF, a request for obtaining the digital certificate, and receiving 215, from the NF, the digital certificate. The verification 211 further comprises, if the digital certificate does not match the one or more attributes associated with the NF, obtaining a new 203 digital certificate signed by a new CA and associated with the interface based on the one or more attributes, and a new trusted CA certificate of the new CA.

According to an embodiment of the invention, the attributes associated with an NF indicate if the NF is a client, a server, or both, and/or requirements pertaining to the secure communications between the NFs, such as level of security (low, high, medium), or certificate extension values, such as extendendKey Usage for IPSec that defines the purpose of a public key contained in a digital certificate.

The one or more isolation requirements associated with an NF indicate the one or more network slices which the NF is deployed in. The one or more isolation requirements associated with the NF may for example indicate whether resources of the NF are shared resource or dedicated resources. An NF with shared resources is deployed in two or more network slices, whereas an NF with dedicated resources is deployed only in one network slice.

According to an embodiment of the invention, the one or more attributes and the one or more isolation requirements associated with the NF, links between the NF and the one or more further NFs, are comprised in a representation of a topology of the network slice. The representation of a topology may be graph-oriented, wherein the NFs deployed in one or more network slices represent the vertices of the graph and the connection between the NFs represents the links of the graph. The representation of a topology may be in a JavaScript Object Notation (JSON) or extensible Markup Language (XML) format.

The one or more attributes and the one or more isolation requirements and/or the representation of a topology may be obtained from a slice network topology manager 105.

It will be appreciated that the method 200 may comprise additional, alternative, or modified, steps in accordance with what is described throughout this disclosure. An embodiment of the method 200 may be implemented as a computer program 704 comprising instructions which when the computer program 704 is executed by the computing device 700 cause the computing device 700 to carry out the method 200 and become operative in accordance with embodiments of the invention described herein. The computer program 704 may be stored in a computer-readable data medium, such as a memory 702. Alternatively, the computer program 704 may be carried by a data carrier signal, e.g., downloaded to the memory via a network interface circuitry 703.

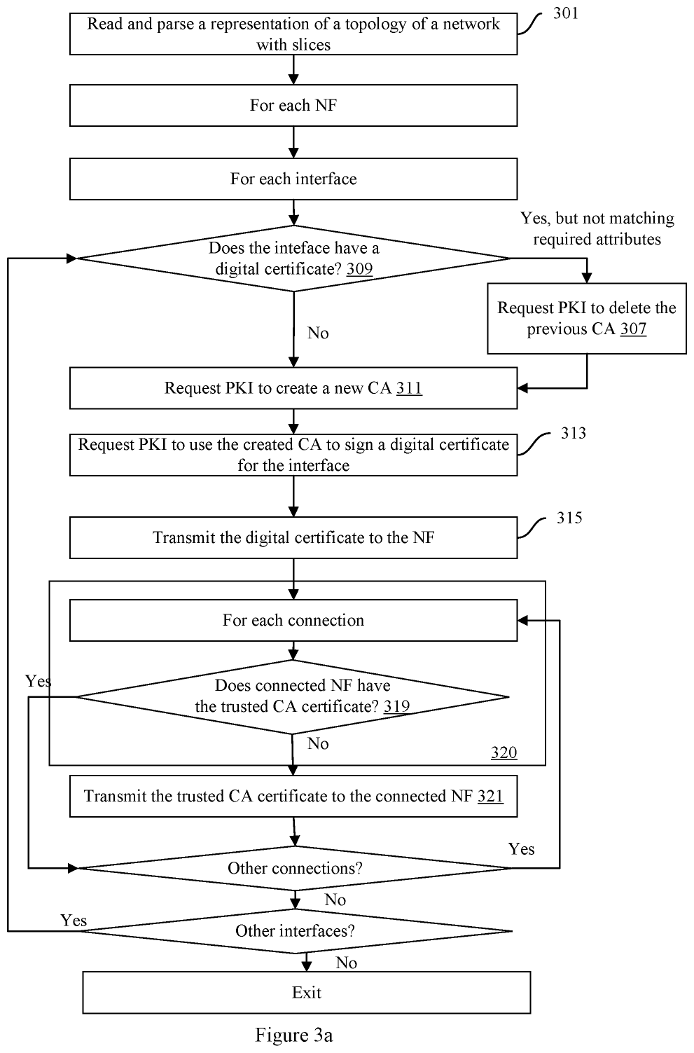

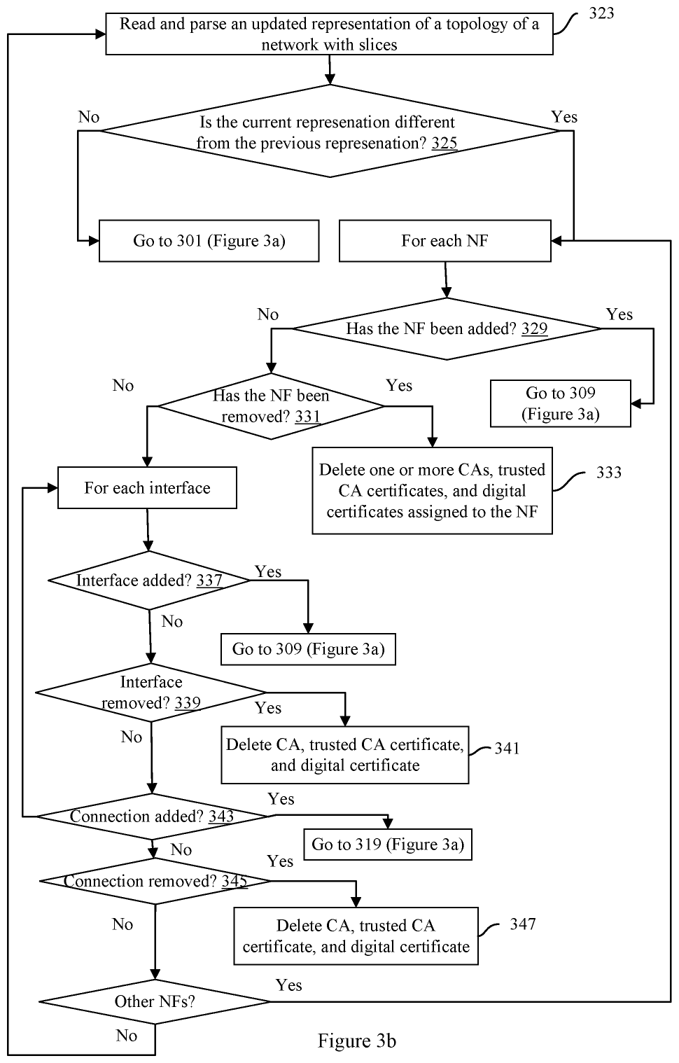

FIG. 3a shows an example flow chart illustrating steps for performing a method by a computing device 700 according to embodiments of the invention. The computing device 700 takes as input a representation of a topology of a network, wherein the representation of the topology comprises two or more NFs deployed in the two or more network slices, links between the NFs, and attributes and isolation requirements associated with the NFs. The computing device reads and parses 301 the representation of the topology. For each interface of each NF, the computing device 700 verifies 309 if the interface has a valid digital certificate. If the interface has a valid digital certificate but the digital certificate does not match the attributes associated with the NF, the computing device 700 may optionally request 307 a PKI to delete the CA that signed the valid digital certificate and a corresponding trusted CA certificate signed by the CA. If the CA of the interface has been deleted or if the interface does not have a valid digital certificate, the computing device 700 requests 311 the PKI to create a new CA, requests 313 the PKI to use the created CA to sign the digital certificate for the interface, and transmits 315 the signed digital certificate to the NF associated with the interface.

Then the computing device 700 identifies 320 one or more trusted domains. The one or more trusted domains are identified by verifying if the NF is connected to one or more further NFs. For each further NF connected to the NF, the computing device verifies 319 if the one or more further connected NFs have the trusted CA certificate. If a further NF does not have the trusted CA certificate, the trusted CA certificate is transmitted 321 to the further NF. If the further NF has already the trusted CA certificate, the next connected NF is verified 325 until all connected NFs are verified.

The computing device 700 may receive 323 updated representations of the topology. FIG. 3b shows a flow chart illustrating steps for performing a method by a computing device 700 according to embodiments of the invention in case of updates to the representation of the topology.

If an updated representation of the topology differs 325 from the previous representation, one of the following cases may occur:
the NF has been removed (331, 333): in this case, one or more CAs, one or more trusted CA certificates, and one or more digital certificates assigned to one or more interfaces of the NF, are removed 333;
a new NF has been added (329, 309-321): in this case, for each interface of the NF, a new CA, a new trusted CA certificate, and a new digital certificate, are created and transmitted to the NF;
an interface has been added to an NF (337, 309-321): in this case a new CA, a new trusted CA certificate, and a new digital certificate, are created and transmitted to the NF;
an interface of an NF has been removed (339, 341): in this case, the CA, the trusted CA certificate, and the digital certificate assigned to the interface, are removed 341;
a connection between an NF and a further NF via an interface has been added (343, 319-321): in this case, a trusted CA certificate of a CA that signed a digital certificate of the interface of the NF is transmitted to the further NF;
a connection between an NF and a further NF has been removed (345, 347): in this case, the CA, the trusted CA certificate, and the digital certificate assigned to the interface connecting the NF and the further NF, are removed 345.

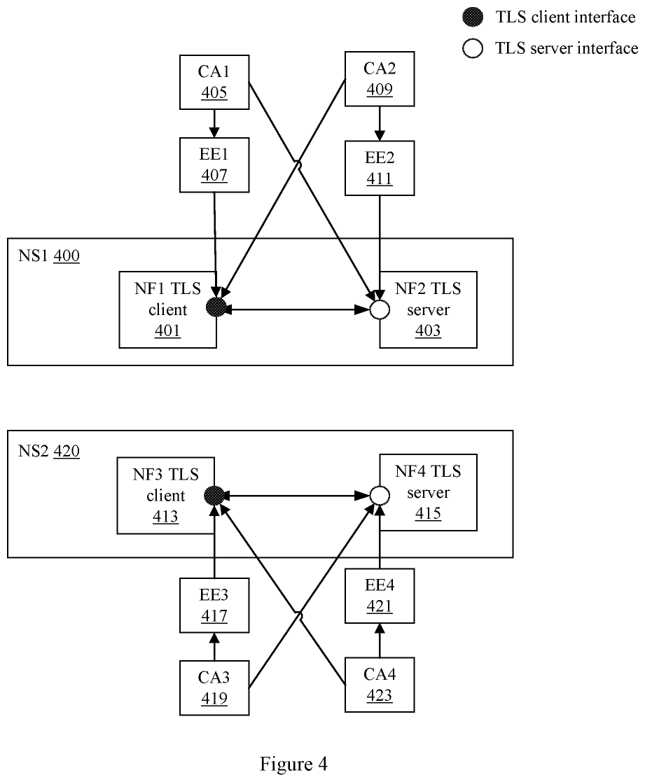

FIG. 4 shows an example system in which a solution according to embodiments of the invention may be implemented. The system comprises two NFs (NF1 401 and NF2 403) deployed in a first network slice NS1 400, and two NFs (NF3 413 and NF4 415) deployed in a second network slice NS2 420. The isolation requirement of NF1 401 indicates that NF1 401 is a TLS client, and the isolation requirement of NF2 403 indicates that NF2 403 is a TLS server. For example, NF1 may be a Session Management Function (SMF) and NF2 may be an Access and Mobility Management Function (AMF) of a 5GC architecture. Furthermore, NF3 413's isolation requirement indicates that NF3 401 is a TLS client, and NF4 413's isolation requirement indicates that NF4 415 is a TLS server. For example, NF3 may be an Authentication Server Function (AUSF) and NF4 may be a Unified Data Management (UDM) of the 5GC.

NF1 401 and NF2 403 are deployed in a same first trusted domain, and NF3 413 and NF4 415 are deployed in a same second trusted domain. An orchestrator, performing a method 200 as described above, would request a PKI to create four new CAs: a first CA (CA1) 405 for NF1, a second CA (CA2) 409 for NF2, a third CA (CA3) 419 for NF3, and a fourth CA (CA4) 423 for NF4. Subsequently, four digital certificates, EE1 407, EE2 411, EE3 417, and EE4 421 are created. For example, EE1 may be a X.509 client certificate 407, signed by the first CA 405, and EE2 may be a X.509 server certificate 411 signed by the second CA 409. NF1 receives the digital certificate EE1 and a trusted CA certificate signed by CA2. NF2 receives the digital certificate EE2 and a trusted CA certificate signed by CA1. NF1 and NF2 may then establish secure communications as follows: NF1 may authenticate NF2 by requesting the X.509 server certificate (EE2) to NF2 and using the trusted CA certificate of CA2 to verify EE2, and NF2may authenticate NF1 by requesting the X.509 client certificate (EE1) to NF1 and using the trusted CA certificate of CA1 to verify the EE1.

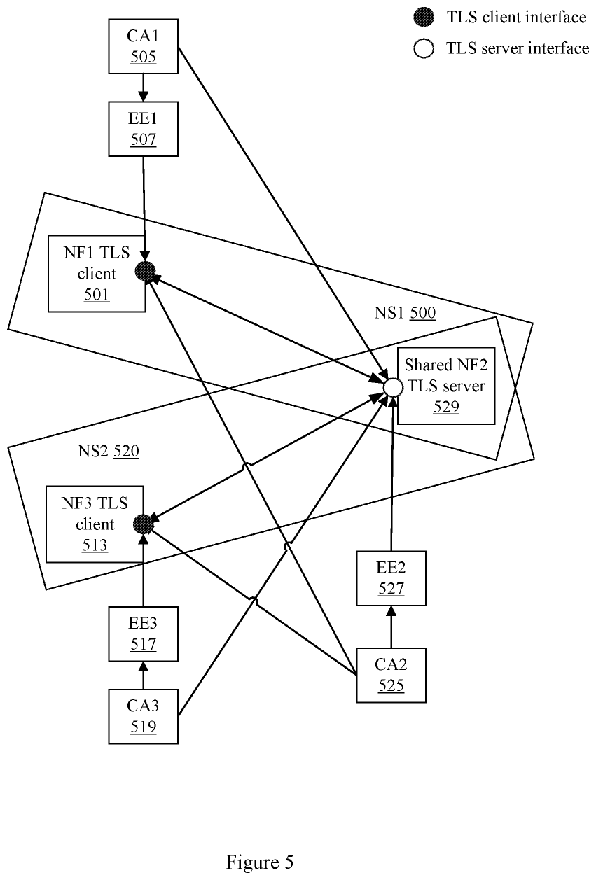

FIG. 5 shows an example system in which a solution according to embodiments of the invention may be implemented. The system comprises three NFs (NF1 501, NF2 529, and NF3 513). NF1 and NF3 are dedicated network functions, i.e., NF1 (e.g., a TLS client) is deployed in a first slice NS1 500, and NF3 (e.g., a TLS client) is deployed in a second slice NS2 520. NF3 (e.g., a TLS server) is shared between the first and the second slice, i.e., a same interface of NF3 is used for communicating with both NF1 and NF3. The system has two trusted domains: the connection between NF1 and NF2 is the first trusted domain, and the connection between NF3 and NF2 is the second trusted domain. An orchestrator performing a method 200 as described above, would request a PKI to create three new CAs: a first CA (CA1 505) for NF1, a second CA (CA2 525) for NF2, and a third CA (CA3 519) for NF3. Subsequently, three digital certificates are created: EE1 507 (e.g., a X.509 client certificate), EE2 527 (e.g., a X.509 server certificate), and EE3 517 (e.g., a X.509 client certificate). NF1will receive the digital certificate EE1 and a trusted CA certificate signed by CA2. NF2 will receive the digital certificate EE2, a trusted CA certificate signed by CA1, and a trusted CA certificate signed by CA3. NF3 will receive the digital certificate EE3 and a trusted CA certificate signed by CA2. Subsequently, NF1, NF2, and NF3, may establish secure communications as follows:
NF1 may authenticate the shared NF2 by requesting the X.509 server certificate (EE2) to NF2 and using the trusted CA certificate of CA2 to verify the digital certificate EE2,
NF3 may authenticate the shared NF2 by requesting the X.509 server certificate (EE2) to NF2 and using the trusted CA certificate of CA2 to verify the digital certificate EE2, and
NF2 may authenticate NF1 by requesting the X.509 client certificate (EE1) to NF1 and using the trusted CA certificate of CA1 to verify the digital certificate EE1, and authenticate NF3 by requesting the X.509 client certificate (EE3) to NF3 and using the trusted CA certificate of CA3 to verify the digital certificate EE3.

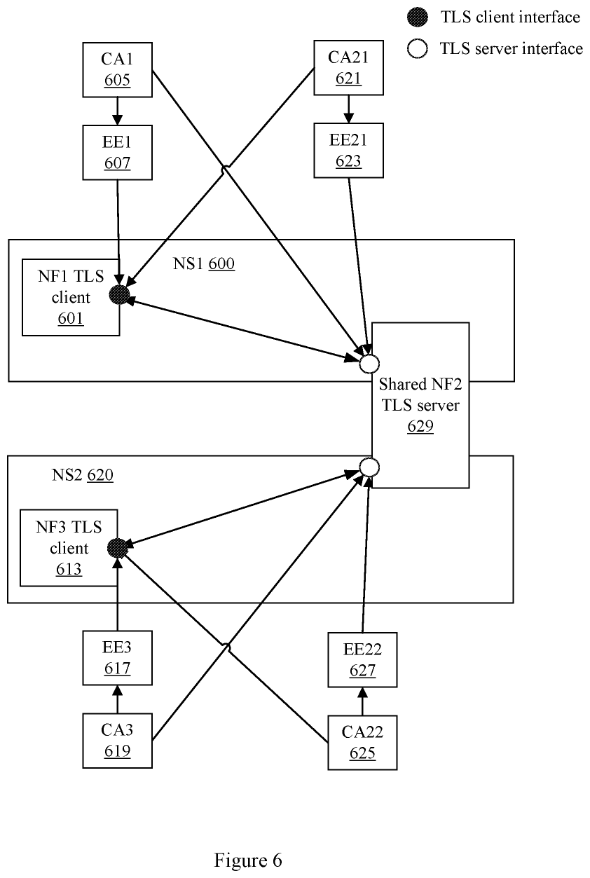

FIG. 6 shows an example system in which a solution according to embodiments of the invention may be implemented. The system comprises three NFs (NF1 601, NF2 629, and NF3 613). NF1 and NF3 are dedicated network functions, i.e., NF1 (e.g., a TLS client) is deployed in a first network slice NS1 600, and NF3 (e.g., a TLS client) is deployed in a second network slice NS2 620. NF3 (e.g., a TLS server) is shared between the first and the second network slice, but differently from FIG. 5, NF3 has a first interface used by the first network slice and a second interface used by the second network slice. In this case, an orchestrator performing a method 200 as described above, would request a PKI to create four new CAs: CA1 605 for NF1, CA21 621 and CA22 625 for NF2, and CA3 619 for NF3. Subsequently, four digital certificates are created: EE1 607 (e.g., a X.509 client certificate), EE21 623 (e.g., a X.509 server certificate), E22 627 (e.g., a X.509 server certificate), and EE3 617 (e.g., a X.509 client certificate). NF1 will receive the digital certificate EE1 and a trusted CA certificate signed by CA21. NF2 will receive the digital certificate EE21, the digital certificate E22, a trusted CA certificate signed by CA1, and a trusted CA certificate signed by CA3. NF3will receive the digital certificate EE3 and a trusted CA certificate signed by CA22. NF1, NF2, and NF3, may then establish secure communications as follows:
NF1 may authenticate the shared NF2 by requesting the X.509 server certificate (EE21) to NF2 and using the trusted CA certificate of CA21 to verify the digital certificate EE21,
NF3 may authenticate the shared NF2 by requesting the X.509 server certificate (E22) to NF2 and using the trusted CA certificate of CA22 to verify the digital certificate E22,
NF2 may authenticate NF1 by requesting the X.509 client certificate (EE1) to NF1 and using the trusted CA certificate of CA1 to verify the digital certificate EE1, and authenticate NF3 by requesting the X.509 client certificate (EE3) to NF3 and using the trusted CA certificate of CA3 to verify the digital certificate EE3.

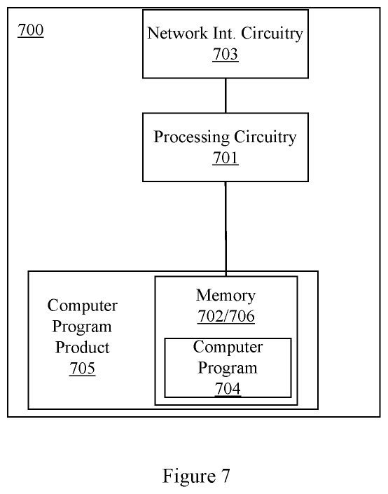

FIG. 7 is a block diagram illustrating an embodiment of the computing device 700, comprising a processor circuitry 701, a computer program product 705 in the form of a computer readable storage medium 706, such as the memory 702, and the network interface circuitry 703.

The processing circuitry 701 may comprise one or more processors, such as Central Processing Units (CPUs), microprocessors, application processors, application-specific processors, Graphics Processing Units (GPUs), and Digital Signal Processors (DSPs) including image processors, or a combination thereof, and the memory 702 comprising a computer program 704 comprising instructions. When executed by the processor(s), the instructions cause the computing device 700 to become operative in accordance with embodiments of the invention described herein, in particular with reference to FIG. 2. The memory 702 may, e.g., be a Random-Access Memory (RAM), a Read-Only Memory (ROM), a Flash memory, or the like. The computer program 704 may be downloaded to the memory 702 by means of a network interface circuitry 703, as a data carrier signal carrying the computer program 704. The network interface circuitry 703 may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the computing device 700 and other computing devices, communications devices, a radio-access network, and/or the Internet. The processing circuitry 701 may alternatively or additionally comprise one or more Application-Specific Integrated Circuits (ASICs), Field-Programmable Gate Arrays (FPGAs), or the like, which are operative to cause the computing device 700 to become operative in accordance with embodiments of the invention described herein. The computing device 700 may a router, gateway, IoT gateway, and any device with computing, storage, and network connectivity.

1. A method for supporting secure communications between network functions, NFs, deployed in a network having two or more network slices, the method performed by a computing device and comprising:
for each one of the NFs, and for each interface of the NF, if the interface does not have a valid digital certificate:
obtaining based on one or more attributes and on one or more isolation requirements associated with the NF, a digital certificate signed by a certification authority, CA, and a trusted CA certificate of the CA;
transmitting to the NF, the obtained digital certificate;
identifying one or more further NFs connected to the NF; and
if one or more of the one or more further NFs do not have the trusted CA certificate, transmitting the trusted CA certificate to the one or more further NFs not having the trusted CA certificate.

2. The method according to claim 1, further comprising
verifying for each interface of each of the NFs, if the interface does not have a valid digital certificate by:
sending to the NF, a request for obtaining the digital certificate;
receiving from the NF, the digital certificate; and
if the digital certificate does not match the one or more attributes associated with the NF, obtaining a new digital certificate signed by a new CA and associated with the interface based on the one or more attributes, and a new trusted CA certificate of the new CA.

3. The method according to claim 1, wherein the obtaining a digital certificate signed by a CA, and a trusted CA certificate of the CA, comprises:
requesting a public key infrastructure, PKI, to create the CA; and
requesting the PKI to use the created CA to sign the digital certificate.

4. The method according to claim 3, wherein a unique CA and a unique digital certificate signed by the unique CA are created for each interface of the NF.

5. The method according to claim 1, further comprising:
if any one of: a connection between an NF and one or more further NFs, an interface of the NF, or the NF, is removed:
deleting the CA, the trusted CA certificate, and a digital certificate assigned to the interface of the NF; and
if any one of: a connection between an NF and one or more further NFs, an interface of the NF, or the NF, is added:
generating a new CA, and
obtaining a new trusted CA certificate and a new digital certificate assigned to the interface of the NF.

6. The method according to claim 1, wherein the attributes associated with an NF indicate one or both of:
if the NF is a client, a server, or both; and
requirements pertaining to the secure communications between the NFs.

7. The method according to claim 1, wherein the one or more isolation requirements associated with an NF indicate the one or more network slices which the NF is deployed in.

8. The method according to claim 1, wherein the one or more attributes and the one or more isolation requirements associated with the NF, connections between the NF and the one or more further NFs, are comprised in a representation of a topology of the network slice.

9. The method according to claim 8, wherein the connections between the NF and the one or more further NFs are determined based on the links of the representation of the topology.

10. The method according to claim 1, wherein the computing device is a Service management and orchestration, SMO, node.

11. A computing device for supporting secure communications between network functions, NFs, deployed in a network having two or more network slices, the computing device comprising a processor and a memory, the memory having stored thereon instructions executable by the processor, the instructions, when executed by the processor, causing the computing device to:
for each one of the NFs, and for each interface of the NF, if the interface does not have a valid digital certificate:
obtain based on one or more attributes and on one or more isolation requirements associated with the NF, a digital certificate signed by a certification authority, CA, and a trusted CA certificate of the CA;
transmit to the NF, the obtained digital certificate;
identify one or more further NFs connected to the NF; and
if one or more of the one or more further NFs do not have the trusted CA certificate, transmit the trusted CA certificate to the one or more further NFs not having the trusted CA certificate.

12. The computing device according to claim 11, wherein the instructions, when executed by the processor, cause the computing device to:
verify for each interface of each of the NFs, if the interface does not have a valid digital certificate by:
sending to the NF, a request for obtaining the digital certificate;
receiving from the NF, the digital certificate; and
if the digital certificate does not match the one or more attributes associated with the NF, obtaining a new digital certificate signed by a new CA and associated with the interface based on the one or more attributes, and a new trusted CA certificate of the new CA.

13. The computing device according to claim 11, wherein the instructions, when executed by the processor, cause the computing device to obtain a digital certificate signed by a CA, and a trusted CA certificate of the CA, by:
requesting a public key infrastructure, PKI, to create the CA; and
requesting the PKI to use the created CA to sign the digital certificate.

14. The computing device according to claim 13, wherein a unique CA and a unique digital certificate signed by the unique CA are created for each interface of the NF.

15. The computing device according to claim 11, wherein the instructions, when executed by the processor, cause the computing device to:
if any one of: a connection between an NF and one or more further NFs, an interface of the NF, or the NF, is removed:
delete the CA, the trusted CA certificate, and a digital certificate assigned to the interface of the NF; and
if any one of: a connection between an NF and one or more further NFs, an interface of the NF, or the NF, is added:
generate a new CA, and
obtain a new trusted CA certificate and a new digital certificate assigned to the interface of the NF.

16. The computing device according to claim 11, wherein the attributes associated with an NF indicate one or both:
if the NF is a client, a server, or both; and
requirements pertaining to the secure communications between the NFs.

17. The computing device according to claim 11, wherein the one or more isolation requirements associated with an NF indicate the one or more network slices which the NF is deployed in.

18. The computing device according to claim 11, wherein the one or more attributes and the one or more isolation requirements associated with the NF, connections between the NF and the one or more further NFs, are comprised in a representation of a topology of the network slice.

19. The computing device according to claim 18, wherein the connections between the NF and the one or more further NFs are determined based on the links of the representation of the topology.

20. The computing device according to claim 11, wherein the computing device is a Service management and orchestration, SMO, node.

21.-23. (canceled)
